(19) United States
(12) Patent Application Publication
(10) Pub. No.: US 2014/0368354 A1
(43) Pub. Date: Dec. 18, 2014

(54) CENTRAL ALARM (CA) UNIT IN A GAS MONITORING SYSTEM INCLUDING GAS SENSORS AND GAS SENSOR CONTROLLERS

(71) Applicant: Integrated Sensing Solutions, Inc., Pittsburgh, PA (US)

(72) Inventor: James Skourlis, Coraopolis, PA (US)

(21) Appl. No.: 14/476,857

(22) Filed: Sep. 4, 2014

Related U.S. Application Data
(63) Continuation of application No. 13/753,509, filed on Jan. 29, 2013.

(51) Int. Cl. G01D 4/00; G08B 21/14

(52) U.S. Cl. CPC G01D 4/002; G08B 21/14
USPC 340/870.02

(57) ABSTRACT

A central alarm (CA) unit in a gas monitoring system including gas sensors and gas sensor controllers operatively connected to respective gas sensors comprises a communications module configured to communicate with the gas sensor controllers, wherein each gas sensor controller is configured to communicate with respective gas sensors, and a gas sensor monitoring module configured to receive from each gas sensor controller a signal including status information of the gas sensors operatively connected to the respective gas sensor controller.

### BACKGROUND

Sensors for detecting hazardous gases may be used to monitor potentially hazardous environments such as mines and industrial facilities that use or produce combustible and other hazardous gases. These sensors are located throughout the monitored location and thus, conventionally, monitoring of such sensors takes place locally at the monitored location.

### BRIEF DESCRIPTION OF THE DRAWINGS

The present disclosure describes a central alarm (CA) unit for use in a gas monitoring system including gas sensors and gas sensor controllers. The CA unit that improves efficiency and efficacy of gas monitoring at a central location in the monitored facility or remotely to the monitored facility.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a schematic drawing of an exemplary gas monitoring system including a central alarm unit.

FIG. 2 illustrates a block diagram of the exemplary gas monitoring system of FIG. 1.

FIG. 3 illustrates an exemplary screen display that may be displayed by the central alarm unit of FIGS. 1 and 2.

FIG. 4 illustrates another exemplary screen display that may be displayed by the central alarm unit of FIGS. 1 and 2.

FIG. 5 illustrates an exemplary simplified gas monitoring information message that includes aggregated or disaggregated alarm status information of the alarm sensors of the system of FIGS. 1 and 2.

FIG. 6 illustrates an exemplary method for a central alarm unit in a gas monitoring system.

FIG. 7 illustrates a schematic drawing of an exemplary central alarm unit.

### DETAILED DESCRIPTION

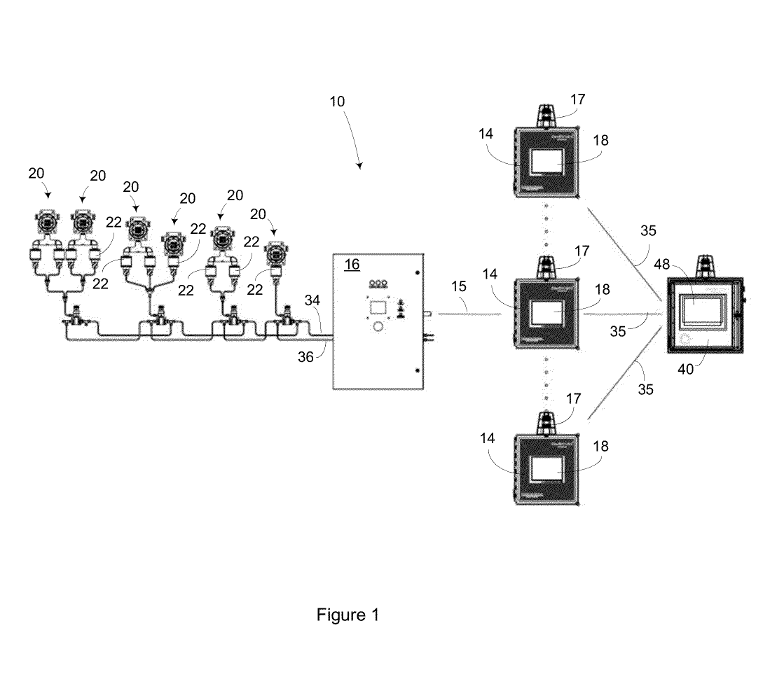

FIG. 1 illustrates a schematic drawing of an exemplary gas monitoring system 10. The system 10 includes gas monitoring stations 20, each of which includes one or more gas sensors 22. The system 10 also includes multiple gas sensor controllers 14. Each gas sensor controller 14 may control multiple gas sensors 22. Communication between gas sensor controllers 14 and corresponding gas sensors 22 is provided by a communication link 15, such as a cable or wireless network link, between the gas sensor controller 14 and the gas sensors 22.

In the embodiment of FIG. 1, each of the gas monitoring stations 20 includes one or two gas sensors 22. In other embodiments, the system 10 may include other combinations of gas sensors per monitoring station 20, including one, two, three, or more gas sensors per monitoring station 20.

The gas sensor controllers 14 convert output signals from the gas sensors 22 into signals representative of gas concentration thereby enabling detection of hazardous gas concentrations. The gas sensor controllers 14 may also issue local alarms to workers in the area where the sensor controller 14 resides. The gas sensor controllers 14 may also control a local alarm device 17 that may be activated if one or more gas sensors 22 detect a dangerous gas condition. The gas sensor controller 14 may further include a display 18 that may locally give additional information regarding the status of the respective gas sensor controller 14 and the gas sensors 22 connected to the particular gas sensor controller 14.

Gas sensor controllers 14 may organize or map gas sensors 22 connected to the respective gas sensor controllers 14 in gas monitoring zones, which are discussed below in more detail. These gas monitoring zones may corresponding to and may mimic the layout of physical or geographical locations being monitored. The gas monitoring zones may assist users in better perceiving or understanding gas conditions at the facility or facilities where the gas sensors 22 reside.

In the illustrated embodiment, the system 10 includes an optional calibration and testing unit 16. The calibration and testing unit 16 may include, among other elements, a supply of testing span gas (also referred to as calibration gas) and a supply of testing zero gas (also referred to as clearance gas). Embodiments where the calibration and testing unit 16 is supplied such as that illustrated in FIG. 1 include a gas distribution network connecting the gas sensors 22 to the calibration and testing unit 16 through conduits 34 and 36 to deliver the testing span and zero gases from the calibration and testing unit 16 to the one or more sensors 22.

The system 10 further includes a central alarm (CA) unit that is located at a location remote from the gas sensor controllers 14 and the gas sensors 22. The CA unit 40 connects to the gas sensor controllers 14. Communication between the CA unit 40 and the gas sensor controllers 14 is provided by communication links 35 such as cable or wireless network links. The CA unit 40 may communicate with multiple gas sensor controllers 14 and, via the gas sensor controllers 14, to multiple gas sensors 22.

The CA unit 40 receives output signals that are representative of gas alarms from the gas sensor controllers 14 thereby enabling remote monitoring of hazardous gas conditions. Based on the received signals, the CA unit 40 may issue or display alarms at the remote location. The CA unit 40 may control devices (not shown) remotely that may be activated if a gas sensor 22 detects a dangerous gas condition and thus the corresponding gas sensor controller 14 issues an alarm. The CA unit may include a display 48 that remotely present information regarding the status of the system 10 including respective gas sensor controllers 14 connected to the CA unit 40 and gas sensors 22 connected to the gas sensors controllers 14.

In one embodiment, the CA unit 40 also includes the capability of communicating electronic messages (e.g., email, text messages, and so on) to remote computers. The electronic messages may include information representative of gas alarms received from the gas sensor controllers 14, thereby enabling monitoring of hazardous gas conditions at any location at which an electronic message may be received. The electronic messages may include information representative of gas alarms in text form or in graphical or pictorial form to give recipients of the electronic messages a better understanding of the gas conditions at the facility or facilities where the gas sensors 22 reside. In one embodiment, the electronic messages include information representative of gas alarms in graphical form arranged by gas monitoring zones as disclosed in more detail below.

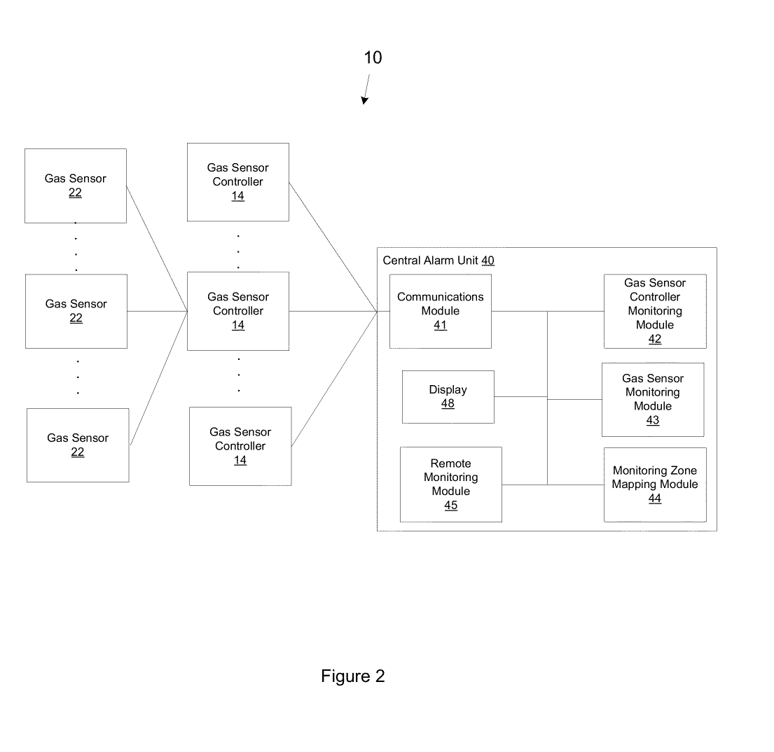

FIG. 2 illustrates a block diagram of the exemplary gas monitoring system 10. As discussed above, the system 10 includes gas sensors 22, gas sensor controllers 14, and the CA unit 40.

In the illustrated embodiment, the CA unit 40 includes a communications module 41 that communicates with the gas sensor controllers 14, which in turn, as discussed above, communicate with respective gas sensors 22. In one embodiment, the communications module 41 also communicates with remote computers through a network (e.g., intranet, Internet, etc.).

The exemplary CA unit 40 further includes a gas sensor controller monitoring module 42 that receives from each gas sensor controller 14 aggregated status information of the gas sensors 22 operatively connected to the respective gas sensor controller 14. The gas sensor controller monitoring module 42 may also cause graphical display of information relating to the aggregated status information. In one embodiment, the CA unit 40 includes the display 48 (see FIG. 1) and the sensor controller monitoring module 42 causes graphical display of information relating to the aggregated status information on the display 48. In other embodiments, the sensor controller monitoring module 42 causes graphical display of information relating to the aggregated status information on a display or displays other than the display 48.

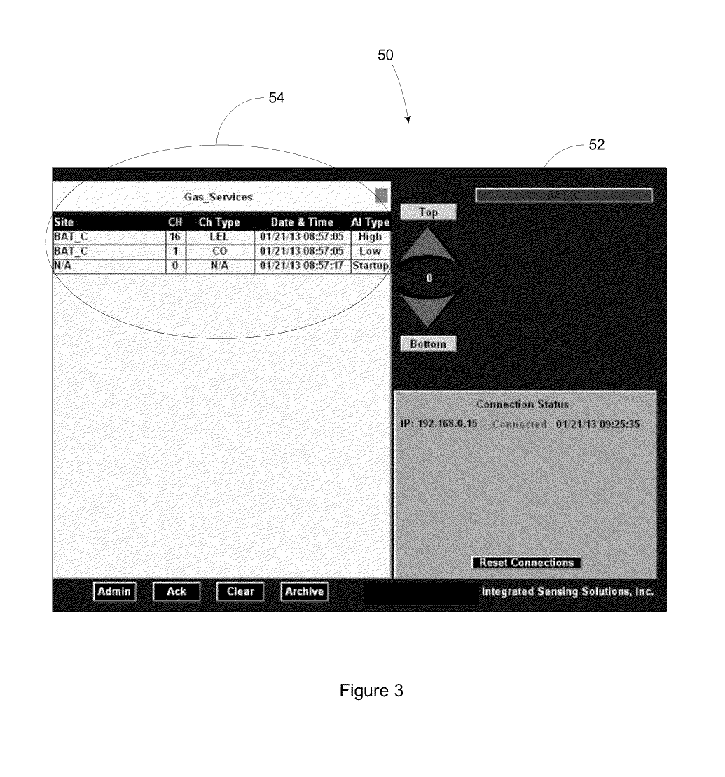

For example, FIG. 3 illustrates an exemplary screen display 50 that the gas sensor controller monitoring module 42 may cause to be displayed on the display 48. In the illustrated embodiment, a gas sensor controller graphical indicator 52 corresponding to the aggregated status information of gas sensors 22 operatively connected to the respective gas sensor controller 14 is displayed. In the illustrated embodiment, the gas sensor controller graphical indicator 52 corresponds to a gas sensor controller 14 labeled BAT_C. The gas sensor controller graphical indicator 52 aggregates the status information of the respective gas sensors 22 in the sense that the gas sensor controller graphical indicator 52 is displayed in, for example, a particular color that indicates the aggregated alarm status of gas sensors 22 operatively connected to the gas sensor controller 14 labeled BAT_C.

In the illustrated example, a Gas Services section 54 corresponding to the respective gas sensor controller 14 (in the illustrated embodiment the gas sensor controller labeled BAT_C) is also displayed in the screen display 50. The Gas Services section 54 indicates that the gas sensor controller labeled BAT_C is operatively connected to at least two gas sensors corresponding to channels 1 and 16 of the gas sensor controller labeled BAT_C.

In the illustrated embodiment, the Gas Services section 54 lists channel 16 of the gas sensor controller 14 labeled BAT_C as an LEL type gas sensor and being on a High alarm state. The Gas Services section 54 further lists the Date & Time at which the alarm status of the channel 16 was updated. Similarly, the Gas Services section 54 lists channel 1 of the gas sensor controller 14 labeled BAT_C as a CO type gas sensor and being on a Low alarm state. The Gas Services section 54 further lists the Date & Time at which the alarm status of the channel 1 was updated.

In the illustrated embodiment, the gas sensor controller monitoring module 42 aggregates the alarm status information of the gas sensors channels 1 and 16 operatively connected to the gas sensor controller labeled BAT_C by displaying the gas sensor controller graphical indicator 52 in a particular color (e.g., red) to indicate that at least one gas sensor (i.e., channel 16) operatively connected to the gas sensor controller labeled BAT_C is in a High alarm state. In other examples (not shown), if the highest alarm level of the gas sensors operatively connected to the gas sensor controller labeled BAT_C is Low, the gas sensor controller graphical indicator 52 may be displayed in yellow. Similarly, if no alarm was present among the gas sensors operatively connected to the gas sensor controller labeled BAT_C, the gas sensor controller graphical indicator 52 may be displayed in green. Other gas sensor controller graphical indicators may include, for example, black for loss of communication, blue for a faulty gas sensor, and so on.

In other embodiments, the gas sensor controller monitoring module 42 may aggregate the alarm status information of the gas sensors operatively connected to the gas sensor controller labeled BAT_C by displaying the gas sensor controller graphical indicator 52 in a particular pattern or a particular shape, and so on.

The gas sensor controller monitoring module 42 may further receive a command requesting disaggregated status information of the gas sensors 22 operatively connected to the respective gas sensor controller 14. In the example of FIG. 3, a user may select the gas sensor controller graphical indicator 52 to request disaggregated status information of the gas sensors operatively connected to the gas sensor controller labeled BAT_C.

With continued reference to FIG. 2, the CA unit 40 further includes a gas sensor monitoring module 43 that receives from each gas sensor controller 14 disaggregated status information of the gas sensors 22 operatively connected to the respective gas sensor controller 14. Upon the gas sensor controller monitoring module 42 receiving, as discussed above, the command requesting disaggregated status information of the gas sensors 22 operatively connected to the respective gas sensor controller 14, the gas sensor monitoring module 43 causes display of gas sensor graphical indicators corresponding to the disaggregated status information of the gas sensors 22.

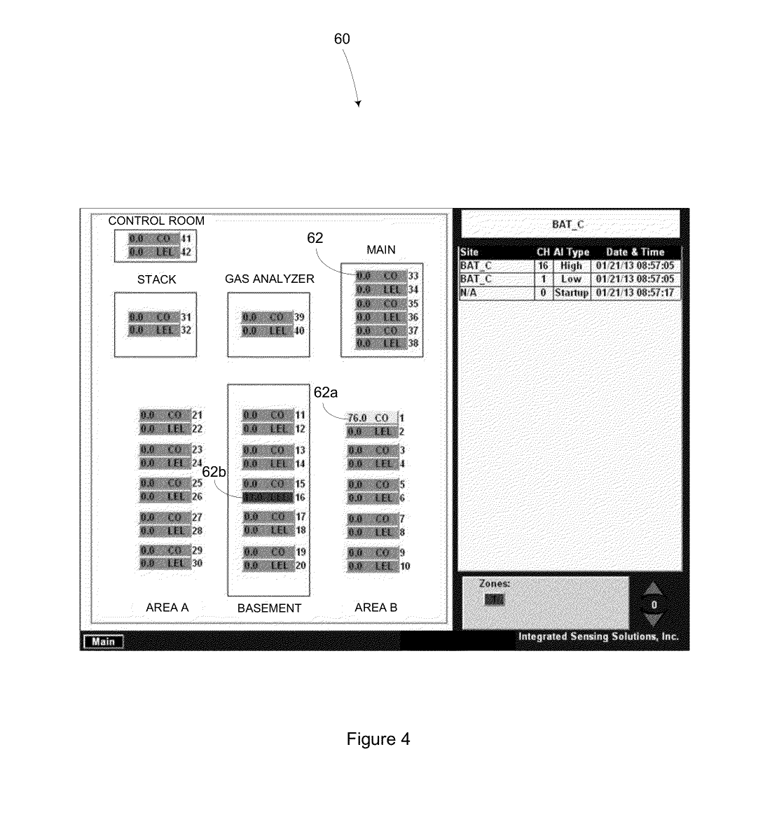

For example, FIG. 4 illustrates an exemplary screen display 60 that the gas sensor monitoring module 43 may cause to be displayed on the display 48 of the CA unit 40. In the illustrated embodiment, gas sensor graphical indicators 62, an example of which are indicators 62a and 62b, are displayed. The gas sensor graphical indicators 62 correspond to the disaggregated status information of each of the gas sensors 22 operatively connected to the respective gas sensor controller 14 (in this case the gas sensor controller labeled BAT_C).

The gas sensor graphical indicators 62 disaggregate the status information of the respective gas sensors 22 because each of the gas sensor graphical indicators 62 includes information regarding a specific gas sensor. In the illustrated embodiment, the gas sensor graphical indicator 62a corresponds to the disaggregated status information of the gas sensor 22 associated with channel 1 of the gas sensor controller labeled BAT_C, while the gas sensor graphical indicator 62b corresponds to the disaggregated status information of the gas sensor 22 associated with channel 16 of the gas sensor controller labeled BAT_C. Moreover, each of the gas sensor graphical indicators 62 is displayed in, for example, a particular color that indicates the alarm status of the specific gas sensor 22.

In the illustrated example, the screen display 60 illustrates that the gas sensor controller labeled BAT_C is operatively connected to forty two gas sensors corresponding to channels 1-42 of the gas sensor controller labeled BAT_C. A gas sensor graphical indicator 62 indicates a gas reading associated with the respective corresponding gas sensor 22. For example, the gas sensor graphical indicator 62a indicates a gas reading of 76.0 for the gas sensor corresponding to channel 1 of the gas sensor controller labeled BAT_C. Similarly, the gas sensor graphical indicator 62b indicates a gas reading of 11.0 for the gas sensor corresponding to channel 16 of the gas sensor controller labeled BAT_C. A gas sensor graphical indicator 62 further indicates a type of gas sensor (e.g., LEL or CO) of the gas sensors 22.

In the illustrated embodiment, the gas sensor monitoring module 43 disaggregates the alarm status information of the gas sensors 22 corresponding to channels 1-42 of the gas sensor controller labeled BAT_C by displaying a gas sensor graphical indicator 62 in a particular color. This is similar to the discussion above regarding gas sensor controller graphical indicators 52 (i.e., red for High alarm, yellow for Low alarm, green for no alarm, black for loss of communication, blue for a faulty gas sensor, etc.) In other embodiments, the gas sensor graphical indicators 62 may be displayed in a particular pattern or a particular shape, and so on to indicate alarm status of the specific gas sensor 22.

In one embodiment, the CA unit 40 or the gas sensor controller 14 organizes or maps gas sensors 22 operatively connected to the gas sensor controller 14 in monitoring zones that each includes one or more gas sensors 22.

With continued reference to FIG. 2, the CA unit 40 further includes a monitoring zone mapping module 44 that receives from each gas sensor controller 14 disaggregated status information of the gas sensors 22 operatively connected to the gas sensor controller 14. The monitoring zone mapping module 44, upon the gas sensor controller monitoring module 42 receiving the command requesting disaggregated status information of the gas sensors 22 operatively connected to the gas sensor controller 14, causes display of gas sensor graphical indicators 62 arranged as groups corresponding to the monitoring zones.

Back to the example of FIG. 4, notice that the gas sensor graphical indicators 62 are arranged as groups labeled CONTROL ROOM, STACK, GAS ANALYZER, MAIN, AREA A, BASEMENT, and AREA B. These groups of gas sensors correspond to monitoring zones that have been so arranged for user ease and convenience as well as to improve efficiency and efficacy of gas monitoring throughout the monitored facility and remotely to the monitored facility.

With continued reference to FIG. 2, the CA unit 40 further includes a remote gas monitoring module 45 that generates gas monitoring information messages. The gas monitoring information messages may be generated upon the aggregated status information or the disaggregated status information indicating that at least one gas sensor 22 is in alarm status. The remote gas monitoring module 45 further causes the communications module 41 to transmit the gas monitoring information messages to remote locations.

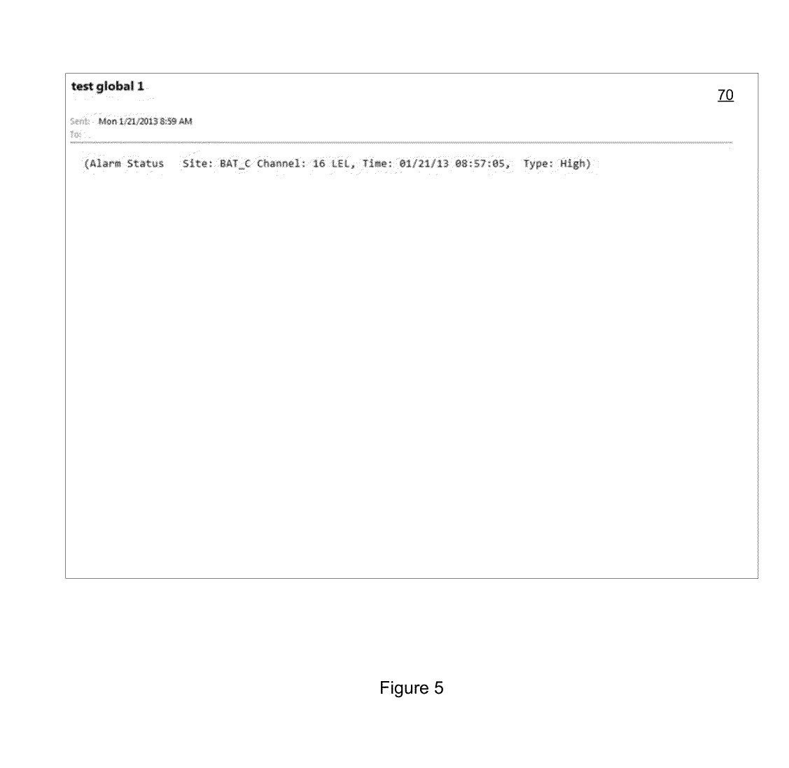

FIG. 5 illustrates an exemplary simplified gas monitoring information message 70 that includes aggregated or disaggregated alarm status information of the alarm sensors 22 to thereby provide central level status information to remote locations.

In the illustrated embodiment, the gas monitoring information message 70 lists the gas sensor controller 14 associated with the gas sensor 22 (in the illustrated case the gas sensor controller labeled BAT_C), the channel of the gas sensor controller 14 to which the gas sensor 22 corresponds (in the illustrated case channel 16), the type of gas sensor 22 (in the illustrated case LEL), the date and time at which the alarm status of the alarm sensor 22 in channel 16 was updated, and the type of alarm (in this case High).

In one embodiment (not shown), the gas monitoring information message 70 includes data corresponding to the aggregated or disaggregated status information arranged in groups corresponding to monitoring zones to thereby provide central level status information to remote locations organized by monitoring zones. In another embodiment (not shown), the gas monitoring information message 70 includes data corresponding to the aggregated or disaggregated status information including gas sensor graphical indicators similar to those described above in reference to the screen display 60 of FIG. 4. The gas sensor graphical indicators may be arranged in groups corresponding to monitoring zones to thereby provide central level status information to remote locations in graphical form and organized by monitoring zones.

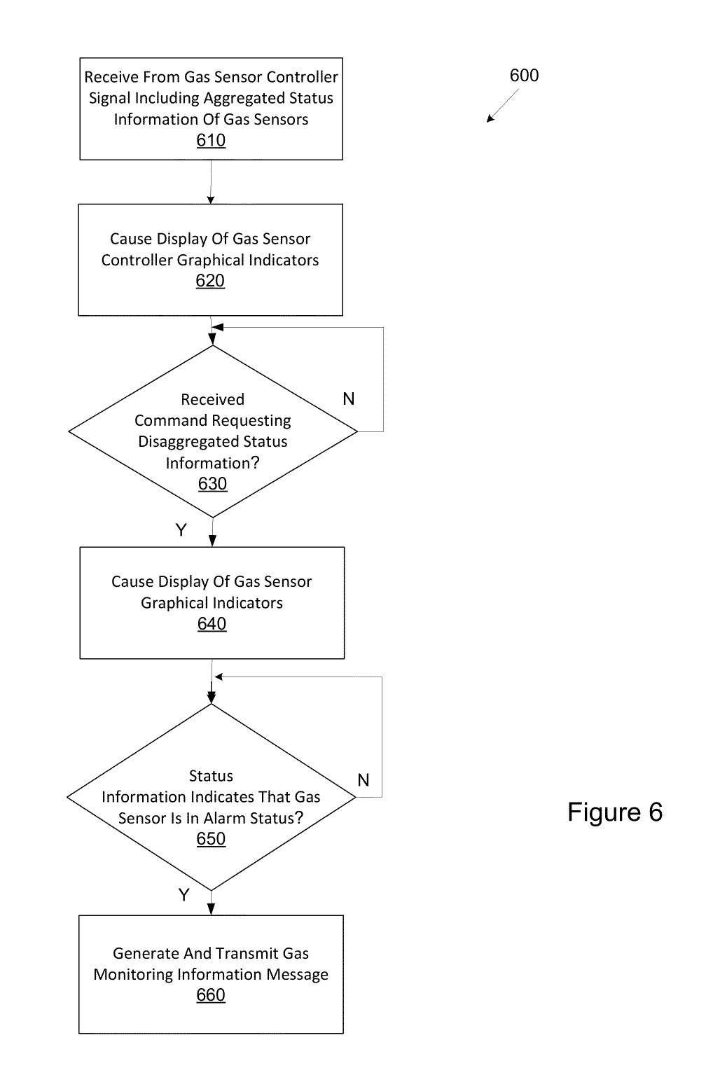

Example methods may be better appreciated with reference to the flow diagram of FIG. 6. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown or described. Moreover, less than all the illustrated blocks may be required to implement an example methodology. Furthermore, additional or alternative methodologies can employ additional, not illustrated blocks.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

In one example, methodologies are implemented as processor executable instructions or operations provided on a computer-readable medium. Thus, in one example, a computer-readable medium may store processor executable instructions operable to perform the method of FIG. 6.

While FIG. 6 illustrates various actions occurring in serial, it is to be appreciated that various actions illustrated could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 6 illustrates an exemplary method 600 for a central alarm (CA) unit in a gas monitoring system including gas sensors and gas sensor controllers operatively connected to respective gas sensors. At 610, the method 600 includes receiving from a gas sensor controller a signal including aggregated status information of gas sensors operatively connected to the gas sensor controller. At 620, the method 600 includes causing display of gas sensor controller graphical indicators. Each gas sensor controller graphical indicator corresponds to the aggregated status information of gas sensors operatively connected to the respective gas sensor controller. At 630, the method 600 includes receiving a command requesting disaggregated status information of the gas sensors operatively connected to the respective gas sensor controller. If the command requesting disaggregated status information of the gas sensors is received, at 640, the method 600 includes causing display of gas sensor graphical indicators. Each gas sensor graphical indicator corresponds to the disaggregated status information of the gas sensors operatively connected to the respective gas sensor controller.

At 650, if at least one of the aggregated status information and the disaggregated status information indicates that at least one gas sensor is in alarm status, the method 600 includes, at 660, generating a gas monitoring information message and transmitting the gas monitoring information message to a remote computer. Each gas monitoring information message includes data corresponding to the aggregated status information or the disaggregated status information to thereby provide central level status information to remote locations. In one embodiment, the gas monitoring information message includes gas sensor graphical indicators.

In one embodiment, the gas sensors operatively connected to the gas sensor controller are organized in monitoring zones that each includes one or more gas sensors and the gas sensor graphical indicators are displayed as groups corresponding to a monitoring zone. In one embodiment, the gas monitoring information messages include the gas sensor graphical indicators arranged in groups corresponding to the monitoring zones to thereby provide central level status information to remote locations organized by monitoring zones.

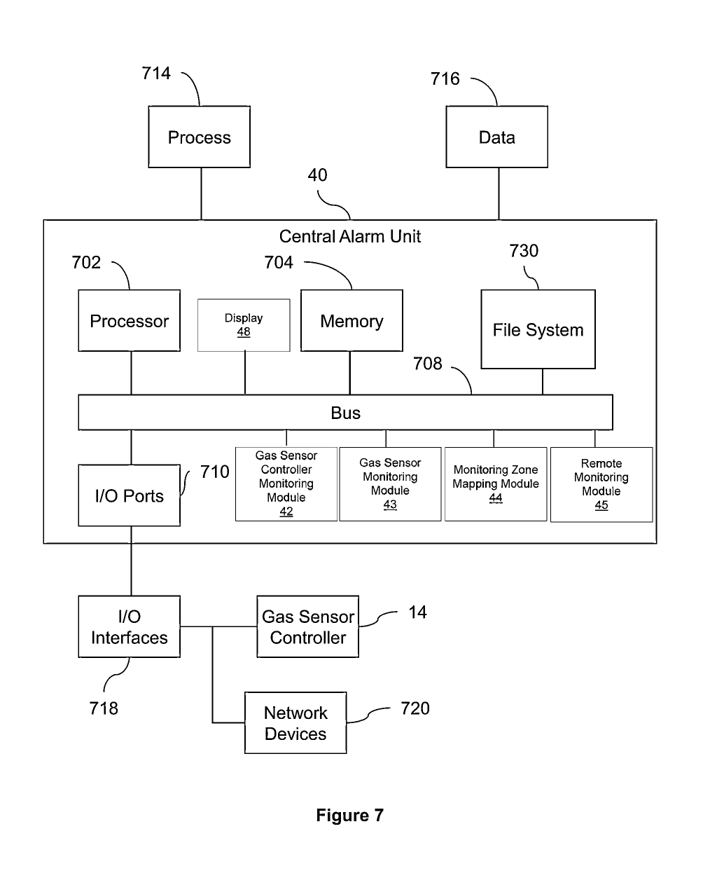

FIG. 7 illustrates a schematic drawing of an exemplary central alarm (CA) unit 40 that includes a processor 702, a memory 704, and I/O Ports 710 operably connected by a bus 708.

The processor 702 can be a variety of various processors including dual microprocessor and other multi-processor architectures. The memory 704 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

The memory 704 can store processes 714 or data 716, for example. The memory 704 can also store an operating system that controls and allocates resources of the CA unit 40.

The bus 708 can be a single internal bus interconnect architecture or other bus or mesh architectures. While a single bus is illustrated, it is to be appreciated that CA unit 40 may communicate with various devices, logics, and peripherals using other busses that are not illustrated (e.g., PCIE, SATA, Infiniband, 1394, USB, Ethernet). The bus 708 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The CA unit 40 may interact with input/output devices via I/O Interfaces 718 and I/O Ports 710. Input/output devices can include, but are not limited to, a keyboard, a microphone, a pointing and selection device, cameras, video cards, displays, gas sensor controllers 14, network devices 720, and the like. The I/O Ports 710 can include but are not limited to, serial ports, parallel ports, and USB ports.

The CA unit 40 can operate in a network environment and thus may be connected to network devices 720 via the I/O Interfaces 718, or the I/O Ports 710. Through the network devices 720, the CA unit 40 may interact with a network. Through the network, the CA unit 40 may be logically connected to remote computers. The networks with which the CA unit 40 may interact include, but are not limited to, a local area network (LAN), a wide area network (WAN), and other networks. The network devices 720 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 720 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

### DEFINITIONS

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Communication,” as used herein, refers to a communication between two or more devices and can be, for example, a network transfer, a file transfer, an applet transfer, an email, a hypertext transfer protocol (HTTP) transfer, and so on. A communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions.

It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Java Script, Java.NET, ASP.NET, VB.NET, Cocoa, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the foregoing detailed descriptions are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A central alarm (CA) unit in a gas monitoring system including gas sensors and gas sensor controllers operatively connected to respective gas sensors, the CA unit comprising:
a communications module configured to communicate with a remote computer and with the gas sensor controllers, wherein each gas sensor controller is configured to communicate with respective gas sensors;
a gas sensor monitoring module configured to receive from each gas sensor controller a signal including status information of the gas sensors operatively connected to the respective gas sensor controller; and
a remote monitoring module configured to generate a gas monitoring information message upon the status information indicating that at least one gas sensor is in alarm status, and further configured to cause the communications module to transmit the gas monitoring information message to the remote computer, each gas monitoring information message including data corresponding to the status information to thereby provide central level status information to a remote location.

2. The central alarm (CA) unit of claim 1, wherein the communications module transmits the gas monitoring information message to the remote computer in electronic mail form.

3. The central alarm (CA) unit of claim 1, wherein the gas sensor monitoring module is further configured to cause display of gas sensor information corresponding to the status information of a respective gas sensor, thereby the CA unit providing real time or near real time status information at a central level.

4. The central alarm (CA) unit of claim 1, wherein the gas sensor controllers convert output signals from the gas sensors into signals representative of sensed gas concentration thereby enabling detection of hazardous gas concentrations, and wherein the gas sensor monitoring module is further configured to cause display of gas sensor information corresponding to the status information of a respective gas sensor including the sensed gas concentration, thereby the CA unit providing real time or near real time status information including gas concentration levels at a central level.

5. The central alarm (CA) unit of claim 1, comprising:
a gas sensor controller monitoring module configured to receive from each gas sensor controller a signal including status information of gas sensors operatively connected to the respective gas sensor controller, wherein the gas sensor controller monitoring module is further configured to cause display of status information of gas sensors operatively connected to the respective gas sensor controller.

6. The central alarm (CA) unit of claim 1, comprising:
a monitoring zone mapping module configured to receive from each gas sensor controller a signal including status information of the gas sensors operatively connected to the respective gas sensor controller, wherein the monitoring zone mapping module is further configured to cause display of gas sensor indicators, each gas sensor indicator corresponding to the status information of a gas sensor, each of the gas sensor indicators displayed as associated with a group, each group corresponding to a monitoring zone.

7. The central alarm (CA) unit of claim 1, wherein the gas sensor controllers convert output signals from the gas sensors into signals representative of sensed gas concentration thereby enabling detection of hazardous gas concentrations, and wherein the gas sensor monitoring module is further configured to cause display of gas sensor information corresponding to the status information of a respective gas sensor including the sensed gas concentration, thereby the CA unit providing real time or near real time status information including gas concentration levels at a central level.

8. A central alarm (CA) unit in a gas monitoring system including gas sensors and gas sensor controllers operatively connected to respective gas sensors, the CA unit comprising:
a communications module configured to communicate with the gas sensor controllers, wherein each gas sensor controller is configured to communicate with respective gas sensors;
a gas sensor monitoring module configured to receive from each gas sensor controller a signal including status information of the gas sensors operatively connected to the respective gas sensor controller; and
a remote monitoring module configured to generate a gas monitoring information message upon the status information indicating that at least one gas sensor is in alarm status.

9. The central alarm (CA) unit of claim 8, wherein the communications module is further configured to communicate with a remote computer and the remote monitoring module is further configured to cause the communications module to transmit the gas monitoring information message to the remote computer, each gas monitoring information message including data corresponding to the status information to thereby provide central level status information to a remote location.

10. The central alarm (CA) unit of claim 9, wherein the communications module transmits the gas monitoring information message to the remote computer in electronic mail form.

11. The central alarm (CA) unit of claim 8, wherein the gas sensor monitoring module is further configured to cause display of gas sensor information corresponding to the status information of a respective gas sensor, thereby the CA unit providing real time or near real time status information at a central level.

12. A central alarm (CA) unit in a gas monitoring system including gas sensors and gas sensor controllers operatively connected to respective gas sensors, the CA unit comprising:
a communications module configured to communicate with the gas sensor controllers, wherein each gas sensor controller is configured to communicate with respective gas sensors; and
a gas sensor monitoring module configured to receive from each gas sensor controller a signal including status information of the gas sensors operatively connected to the respective gas sensor controller.

13. The central alarm (CA) unit of claim 12, comprising:
a remote monitoring module configured to generate a gas monitoring information message upon the status information indicating that at least one gas sensor is in alarm status.

14. The central alarm (CA) unit of claim 13, wherein the communications module is further configured to communicate with a remote computer and the remote monitoring module is further configured to cause the communications module to transmit the gas monitoring information message to the remote computer, each gas monitoring information message including data corresponding to the status information to thereby provide central level status information to a remote location.

15. The central alarm (CA) unit of claim 14, wherein the communications module transmits the gas monitoring information message to the remote computer in electronic mail form.

16. The central alarm (CA) unit of claim 12, wherein the gas sensor monitoring module is further configured to cause display of gas sensor information corresponding to the status information of a respective gas sensor, thereby the CA unit providing real time or near real time status information at a central level.

17. The central alarm (CA) unit of claim 12, wherein the gas sensor controllers convert output signals from the gas sensors into signals representative of sensed gas concentration thereby enabling detection of hazardous gas concentrations, and wherein the gas sensor monitoring module is further configured to cause display of gas sensor information corresponding to the status information of a respective gas sensor including the sensed gas concentration, thereby the CA unit providing real time or near real time status information including gas concentration levels at a central level.

18. The central alarm (CA) unit of claim 12, comprising:
a gas sensor controller monitoring module configured to receive from each gas sensor controller a signal including status information of gas sensors operatively connected to the respective gas sensor controller, wherein the gas sensor controller monitoring module is further configured to cause display of status information of gas sensors operatively connected to the respective gas sensor controller.

19. The central alarm (CA) unit of claim 12, comprising:
a monitoring zone mapping module configured to receive from each gas sensor controller a signal including status information of the gas sensors operatively connected to the respective gas sensor controller, wherein the monitoring zone mapping module is further configured to cause display of gas sensor indicators, each gas sensor indicator corresponding to the status information of a gas sensor, each of the gas sensor indicators displayed as associated with a group, each group corresponding to a monitoring zone.

20. The central alarm (CA) unit of claim 12, wherein the gas sensor controllers convert output signals from the gas sensors into signals representative of sensed gas concentration thereby enabling detection of hazardous gas concentrations, and wherein the gas sensor monitoring module is further configured to cause display of gas sensor information corresponding to the status information of a respective gas sensor including the sensed gas concentration, thereby the CA unit providing real time or near real time status information including gas concentration levels at a central level.
